(19) United States
(12) Patent Application Publication
(10) Pub. No.: US 2018/0258678 A1
(43) Pub. Date: Sep. 13, 2018

(54) REVERSIBLE VENTILATION SLIDE INHIBITOR

(71) Applicant: LOCKTECH SECURITY PTY LTD, Balgowlah (AU)

(72) Inventor: Michael COLLINS, Balgowlah (AU)

(21) Appl. No.: 15/915,080

(22) Filed: Mar. 8, 2018

(30) Foreign Application Priority Data
Mar. 9, 2017 (AU) 2017900817

(51) Int. Cl. E05F 5/00

(52) U.S. Cl. CPC E05F 5/003; E06B 3/42

(57) ABSTRACT

A reversible ventilation slide inhibitor adapted to be positioned on a sliding member, including: a lockable body with first and second passages, a locking barrel located between the first and second passages capable of being rotated between a locked and unlocked position, and a reversible stop piece with first and second pins. Each of the pins adapted to be inserted into either of the passages, thereby making the reversible stop piece reversible between an active and an inactive position. The reversible stop piece in the active position abuts a sliding member, to prevent movement of the sliding member beyond a fixed point on a track on which the sliding member is adapted to slide. When in the inactive position allows the sliding member to bypass the reversible stop piece to an unrestricted opening distance.

### TECHNICAL FIELD

The present disclosure relates to a window or door opening restrictor. More specifically, the present disclosure relates to a restrictor for restricting movement of sliding windows or doors.

### BACKGROUND

Various window opening restrictors have been developed to limit window opening distance and address window safety concerns associated with an increase in high density, multi-storey living.

Window restrictors are used to prevent a window sash opening beyond a fixed point on the window track. While it may be desirable in some circumstances to open a window to its full extent, a fully opened window may pose a risk of inadvertent fails from heights, particularly by children. It is therefore desirable to provide a window restrictor that allows the user the flexibility to fully open a window or restrict a window opening depending on their individual circumstances and applications.

In relation to sliding windows, traditional vent stops and other physical inhibitors of window openings are typically installed inside the elongate window track at the top or bottom of the window frame, or over the window sill. The moveable window frame can slide freely along the window track until further movement is inhibited by abutment with the installed window restrictor, thereby limiting window opening distance.

There are many different types and sizes of windows available and it is a limitation of existing vent stops that may not be appropriate in size or function for all sliding windows or doors.

In some circumstances, the window track at the top or bottom of a window frame may be too narrow to accommodate vent stops that are designed to sit within the window track itself.

Alternatively, in the case of vent stops designed to be positioned on the window sill, the sill itself may be too thick or interior design elements, such as tiles, may render the window sill unusable.

In some cases, safety and/or legislative requirements require window restrictors to be installed on whole buildings with many tens or hundreds of windows. In such circumstances, the installation of existing vent stops comprising multiple components each requiring individual securing devices can be cumbersome, time-consuming and expensive.

The present disclosure seeks to overcome at least some of the deficiencies of existing sliding window restrictors, or to at least provide an alternative.

### SUMMARY

The present disclosure provides a reversible ventilation slide inhibitor, which may be used or applied on windows that slide vertically or horizontally and are typically installed at a fixed point along the track along which a sliding member moves. Window restrictors, and in particular ventilation stops, typically limit the extent to which the window may be opened by inhibiting contact between the stop device and the sliding member. This enables the sash to be opened to a safe ventilation distance.

The present disclosure provides a cost-effective, easy-to-use alternative to existing vent stops for sliding windows and doors, particularly in circumstances where the window or door track and/or window or door sill cannot accommodate a vent stop due to size or physical limitations to installation. The reversible stop piece of the current disclosure may limit the opening distance of a window or door by physically blocking further movement of the sliding sash or sliding member of the window/door when the reversible stop piece is in the active position. The reversible stop piece of the current disclosure may allow the window or door to bypass the reversible stop piece and fully open when the reversible stop piece is in the inactive position.

The current disclosure will herein be described in terms of installation and use on sliding windows, however it should be appreciated that the reversible ventilation slide inhibitor disclosed herein is not limited to application on sliding windows only and may also be used to limit the opening distance of other window and door types and other sliding members.

The present disclosure provides a reversible ventilation slide inhibitor with reversible stop piece including a lockable body with first and second passages, a locking barrel located between the first and second passages within the lockable body and capable of being rotated between a locked and unlocked position, a reversible stop piece with first and second pins, whereby each of the first and second pins of the reversible stop piece are adapted to be inserted into either of the first and second passages of the lockable body, thereby making the reversible stop piece reversible between an active position and an inactive position. In some embodiments, the reversible ventilation slide inhibitor is adapted to be positioned on a window sill onto which a sliding member is installed.

In some embodiments, the reversible stop piece in the active position abuts a sliding member movement from further movement beyond a fixed point on a track on which the sliding member is adapted to slide, and when in the inactive position the reversible stop piece allows the sliding member to bypass the reversible stop piece to an unrestricted opening distance.

According to some embodiments, each of the first and second passages of the lockable body includes a top opening and a bottom opening, whereby each top opening is larger than the bottom opening to allow a securing device to be inserted through the top opening of each passage and to be captured by the smaller bottom opening.

In some embodiments, the first passage of the lockable body is substantially parallel to the second passage of the lockable body. In some embodiments, each of the first and second passages of the lockable body is adapted to receive either the first pin or second pin of the reversible stop piece.

In some embodiments, the first passage comprises an aperture through which the locking barrel is able to rotate between the locked position and the unlocked position.

In some embodiments, the locking barrel is positioned between the first and second passages and accessed via a keyhole located at a front side of the lockable body.

In some embodiments, the locking barrel is capable of being rotated between the locked position and the unlocked position, whereby the locking barrel engages with the first pin of the reversible stop piece that is inserted into the first passage when in the locked position to capture the reversible stop piece and prevent its removal from the lockable body.

In some embodiments, the reversible stop piece consists of a first and a second substantially identical, parallel pins.

In some embodiments, both the first and second pins are secured to an underside of a stop bracket.

In some embodiments, the stop bracket comprises a shelf vertically projecting from one edge of the stop bracket to form a stop ledge.

In some embodiments, each of the first and second pins are adapted to be positioned in either of the first or second passages, thereby making the reversible stop piece reversible.

In some embodiments, once inserted into the lockable body, the pin contained within the first passage of the lockable body engages with the locking barrel when in the locked position to capture the reversible stop piece and prevent its removal from the lockable body.

In some embodiments, once inserted into the lockable body, the pin contained in the second passage of the lockable body stabilises the reversible stop piece and prevents rotational movement of the reversible stop piece upon contact with the sliding member.

In some embodiments, the stop bracket is configured such that when in the active position the stop ledge will protrude over the elongated track of the sliding member and limit the opening of the sliding member beyond a fixed point on the track.

In some embodiments, the stop bracket is reversed and inserted into the lockable body in the inactive position such that the stop ledge protrudes away from the track of the sliding member, thereby allowing the sliding member to bypass the stop ledge and move beyond a fixed point on the track to an unrestricted open position.

### BRIEF DESCRIPTION OF THE DRAWINGS

FIG. 1 schematically illustrates a perspective view of reversible ventilation slide inhibitor, according to an exemplary embodiment of the disclosure;

FIG. 2 schematically illustrates an exploded view of the reversible ventilation slide inhibitor from FIG. 1, according to an exemplary embodiment of the disclosure;

FIG. 3 schematically illustrates a cross-sectional view of reversible ventilation slide inhibitor with stop piece inserted and the locking barrel in the locked position, according to an exemplary embodiment of the disclosure;

FIG. 4A schematically illustrates a cross-sectional view of the lockable body with the locking barrel in the unlocked position and the reversible stop piece partially inserted, according to an exemplary embodiment of the disclosure;

FIG. 4B schematically illustrates a cross-sectional view of the lockable body with locking barrel in unlocked position and stop piece removed, according to an exemplary embodiment of the disclosure;

FIG. 5A schematically illustrates the reversible ventilation slide inhibitor installed on a window or door frame with stop piece in the active position, according to an exemplary embodiment of the disclosure;

FIG. 5B schematically illustrates the reversible ventilation slide inhibitor installed on window or door with stop piece in the inactive position, according to an exemplary embodiment of the disclosure.

### DETAILED DESCRIPTION

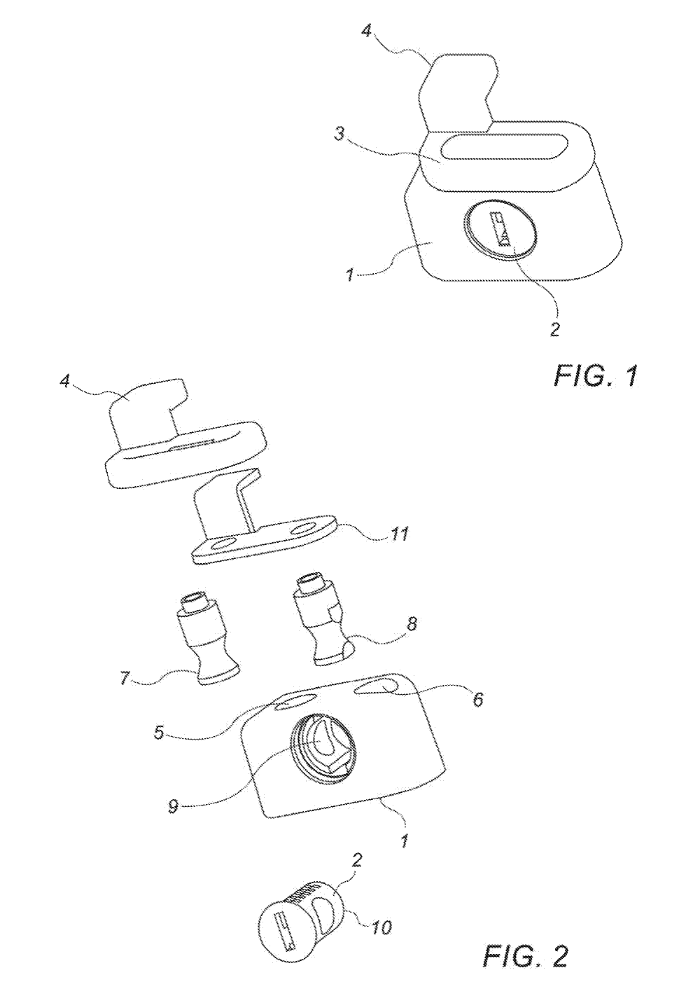

FIG. 1 is an isometric view of the reversible ventilation slide inhibitor in accordance with an exemplary embodiment of the disclosure. The reversible ventilation slide inhibitor is comprised primarily of a lockable body 1, a locking barrel 2 and a reversible stop piece 3. The disclosed embodiments are merely exemplary and are not intended to be limited to the structural and functional details described herein. Terms such as front, back, top and bottom will be used with reference to orientation of the reversible ventilation slide inhibitor in the drawings. In real life applications, the reversible ventilation slide inhibitor may be installed in any orientation required by the specific application.

FIG. 1 depicts the reversible ventilation slide inhibitor with the reversible stop piece 3 inserted into the lockable body 1 such that the stop ledge 4 extends over the back side of the lockable body 1 with the locking barrel 2 facing the front. This particular exemplary embodiment is herein described as the active position. In the alternative, inactive position (not shown), the reversible stop piece 3 may be removed from the lockable body 1 and re-inserted in the reverse position such that the stop ledge 4 extends over the front side of the lockable body 1.

In some embodiments, the reversible ventilation slide inhibitor may be adapted to be positioned on a first sliding member, when movement and opening distance of a second adjacent sliding member is sought to be restricted.

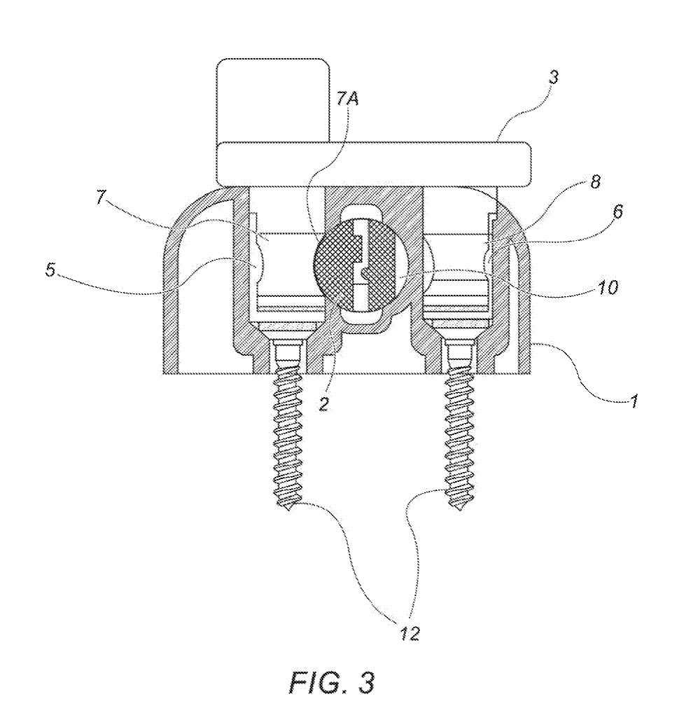

Referring to FIG. 2, the lockable body 1 includes a first passage 5 and a second passage 6. Each of passages 5 and 6 is adapted to receive a fastening means, such as screws 12 (FIG. 3), for fastening the device to a secure structure (see screws 12 in FIG. 3). Each of the first and second passages is also adapted to receive either one of the first pin 7 or second pin 8 of the reversible stop piece 3 depending on the orientation of the reversible stop piece 3. The first passage 5 and second passage 6 are substantially parallel. The first passage 5 and second passage 6 differ only in that the first passage 5 may be in contact with an aperture 9. Locking barrel 2 may be inserted into aperture 9 and may be rotated with a use of a key (not shown) between the locked position, in which the curved edge 10 of the locking barrel 2 will protrude through aperture 9 into first passage 5, and the unlocked position, in which the concave edge 10 of the locking barrel 2 will align with the aperture 9 in the first passage 5, such that locking barrel 2 will not protrude through aperture 9 into first passage 5.

The reversible stop piece 3 is comprised of a first and second substantially identical pins. In some embodiments, the first and second pins may be positioned in parallel to one another. Making the stop piece reversible requires the first pin 7 and the second pin 8 to be substantially identically formed and separated by a distance corresponding to the distance between first passage 5 and second passage 6 of the lockable body 1. Both the first pin 7 and the second pin 8 are secured to the stop bracket 11. The stop bracket 11 may also extend along a portion of one edge of stop bracket 11 into a raised stop ledge 4, which projects vertically up and then away from the stop bracket 11. In some embodiments, stop bracket 11 may comprise a shelf vertically projecting from one edge of the stop bracket 11 to form stop ledge 4. The height and length of the said stop ledge 4 may be manufactured to variable dimensions depending on the dimensions required for different applications, e.g., different window/door sill widths.

The locking barrel 2 is designed to rotate by use of a key (not shown) between a locked position and an unlocked position. In the locked position the curved edge 10 of the locking barrel 2 protrudes through the aperture 9 into the first passage 5 such that it can engage with the pin inserted into the first passage 5 to capture the reversible stop piece 3 and prevent its removal from the lockable body 1. In the unlocked position, the concave edge 10 of the locking barrel 2 aligns with the aperture in the first passage 5. In this position, there is no protrusion through the aperture 9 and consequently no contact between the reversible stop piece 3 and the locking barrel 2, thereby allowing the reversible stop piece to be inserted and removed freely from the lockable body 1.

Referring to FIG. 3, the reversible ventilation slide inhibitor is depicted showing screws 12, inserted through both the first passage 5 and second passage 6 and captured by an opening at the bottom of each passage for fastening the device to a secure structure. In some embodiments other fastening means may be used instead of screws, such as bolts, glue, rivets nails and the like. In some embodiments, the diameter of the bottom opening, which is located at the bottom side of each passage is smaller compared to the diameter of the top opening of each passage, which is located at each of the passages' upper side. The reversible stop piece 3 is then shown inserted into the lockable body 1 above the screws 12, e.g., through the top opening of each of passages 5 and 6, which are of a larger diameter compared to the diameter of the bottom side opening. The locking barrel 2 is depicted in the locked position to demonstrate how the curved edge 10 of the locking barrel 2 protrudes through the aperture 9 and engages with the concave portion 7A of the first pin 7 inserted into the first passage 5. In this position the locking barrel 2 is in the locked position and the reversible stop piece 3 is captured and unable to be removed from the lockable body 1.

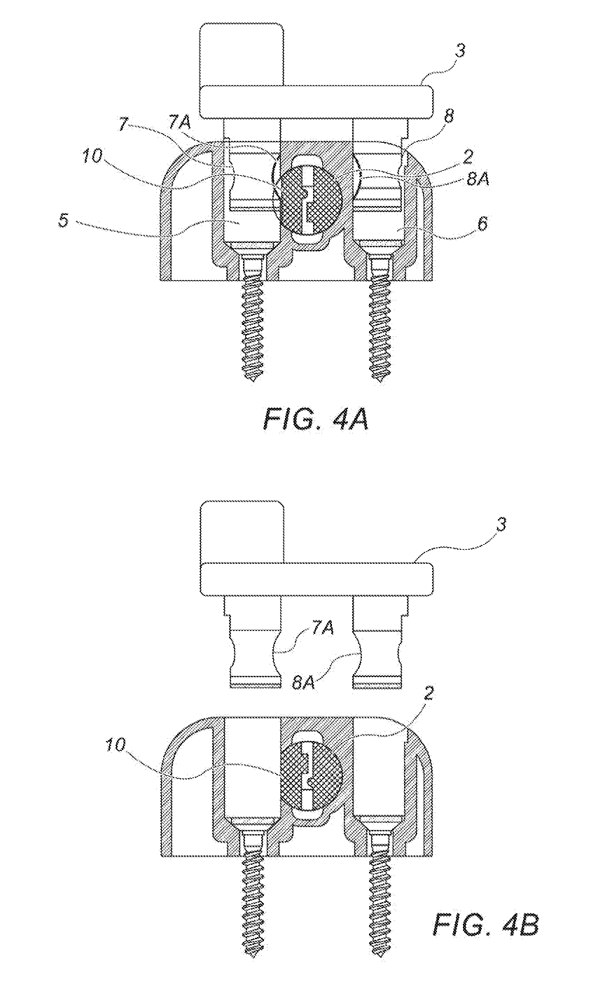

Referring to FIG. 4A, the locking barrel 2 is depicted in the unlocked position. The locking barrel may be rotated by use of a key (not shown) such that the concave edge 10 of the locking barrel 2 will align with aperture 9 of the first passage. In this position the locking barrel 2 does not protrude through the aperture 9 and does not engage with the pin inserted into the first passage 3. In the absence of any physical inhibition to its removal, the reversible stop piece 3 can be lifted freely and removed from the lockable body 1 as shown by FIG. 4B.

The substantially similar configuration of both the first pin 7 and second pin 8 enable the locking barrel 2 to engage either the first pin 7 or the second pin 8 depending on the orientation of the reversible stop piece 3 inserted into the lockable body such that the locking mechanism described herein can capture the reversible stop piece 3 in either the active or the inactive position. That is, in the active position, first pin 7 would be inserted into first passage 5 (while second pin 8 would be inserted into second passage 6), thereby enabling locking barrel 2 to engage the concave portion 7A of first pin 7 such to capture stop piece 3 in its active orientation. In the inactive position of stop piece 3, it is second pin 8 that is inserted to first passage 5 (while first pin 7 would be inserted into second passage 6), thereby enabling locking barrel 2 to engage the concave portion 8A of second pin 8 such to capture stop piece 3 in its opposite inactive orientation.

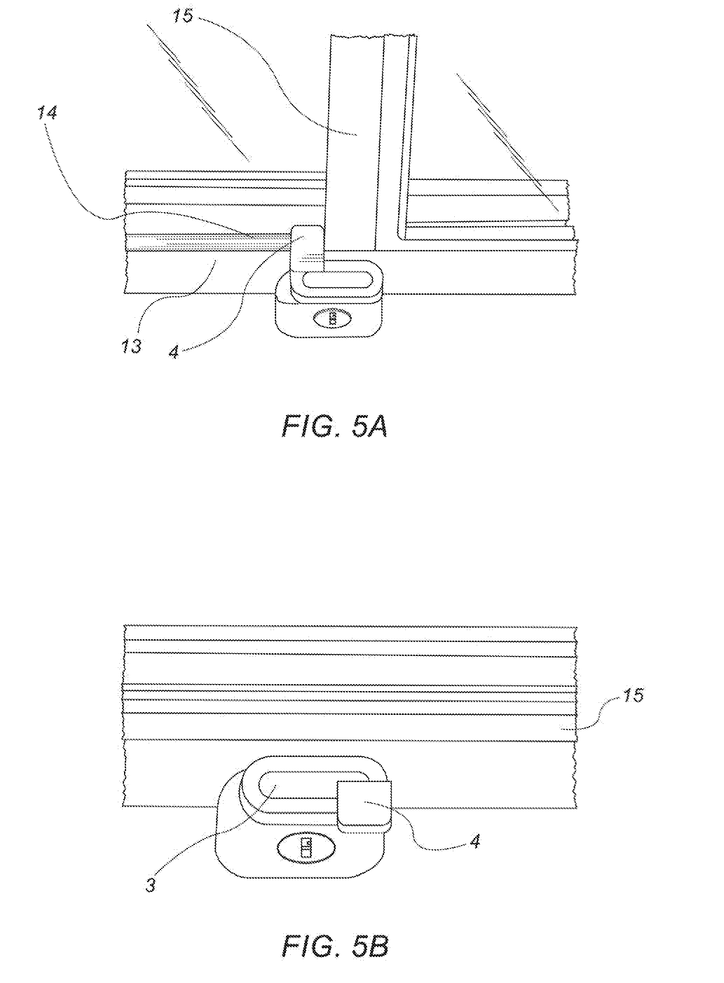

FIG. 5A depicts a real-life application of the reversible ventilation slide inhibitor fastened to a secure structure. In this exemplary embodiment, reversible ventilation slide inhibitor is fastened onto window sill 13 onto which a sliding member is installed. With the reversible stop piece 3 in the active position such that the stop ledge 4 traverses the window sill 13 of a sliding member, e.g., a window 15, to extend over the track 14. In this position a window sash, may move freely until abutment with the stop ledge 4 will inhibit further movement beyond the fixed restricted opening position.

FIG. 5B depicts the reversible ventilation slide inhibitor installed in the same position on window sill 13 but with the reversible stop piece 3 in the reversed inactive position such that the stop ledge 4 extends over the front side of the reversible ventilation slide inhibitor and away from the window 15. In the inactive position the sliding member (e.g., window 15 of FIG. 5A) can bypass the stop ledge 4 and move to an unrestricted open position beyond the reversible ventilation slide inhibitor.

1. A reversible ventilation slide inhibitor with reversible stop piece comprising:
a lockable body with first and second passages;
a locking barrel located between the first and second passages within the lockable body and capable of being rotated between a locked position and an unlocked position;
a reversible stop piece with first and second pins, wherein each of the first and second pins of the reversible stop piece are adapted to be inserted into either one of the first and second passages of the lockable body, thereby making the reversible stop piece reversible between an active position and an inactive position;
wherein the reversible ventilation slide inhibitor is adapted to be positioned on a window sill onto which a sliding member is installed; and
wherein the reversible stop piece in the active position abuts a sliding member movement beyond a fixed point on a track on which the sliding member is adapted to slide, and when in the inactive position the reversible stop piece allows the sliding member to bypass the reversible stop piece to an unrestricted opening distance.

2. The reversible ventilation slide inhibitor according to claim 1, wherein each of said first and second passages comprise a top opening and a bottom opening, wherein each top opening is of a diameter larger than the diameter of the bottom opening to allow a securing device to be inserted through the top opening of each passage and to be captured by a smaller diameter bottom opening.

3. The reversible ventilation slide inhibitor according to claim 1, wherein the first passage is substantially parallel to said second passage.

4. The reversible ventilation slide inhibitor according to claim 1, wherein each of said first and second passages is adapted to receive either the first pin or second pin of the reversible stop piece.

5. The reversible ventilation slide inhibitor according to claim 1, wherein the first passage comprises an aperture through which the locking barrel is able to rotate between the locked position and the unlocked position.

6. The reversible ventilation slide inhibitor according to claim 5, wherein said locking barrel is capable of being rotated between the locked position and the unlocked position, further wherein the locking barrel engages with the first pin of the reversible stop piece that is inserted into the first passage when in the locked position to capture the reversible stop piece and prevent its removal from the lockable body.

7. The reversible ventilation slide inhibitor according to claim 6, wherein the reversible stop piece comprises a first and a second parallel pins.

8. The reversible ventilation slide inhibitor according to claim 7, wherein the first and second pins are secured to an underside of a stop bracket.

9. The reversible ventilation slide inhibitor according to claim 8, wherein the stop bracket comprises a shelf vertically projecting from one edge of the stop bracket to form a stop ledge.

10. The reversible ventilation slide inhibitor according to claim 9, wherein the stop bracket is adapted such that when in the active position the stop ledge will protrude over an elongated track of the sliding member and limit opening of the sliding member beyond a fixed point on the track.

11. The reversible ventilation slide inhibitor according to claim 9, wherein the stop bracket is reversed and inserted into the lockable body in the inactive position whereby the stop ledge protrudes away from the track of the sliding member, thereby allowing the sliding member to bypass the stop ledge and move beyond a fixed point on the track to an unrestricted open position.

12. The reversible ventilation slide inhibitor according to claim 1, wherein the locking barrel is positioned between the first and second passages and accessed via a keyhole located at a front side of the lockable body.

13. The reversible ventilation slide inhibitor according to claim 1, wherein each of the first and second pins are adapted to be positioned in either of the first or the second passages, thereby making the reversible stop piece reversible.

14. The reversible ventilation slide inhibitor according to claim 1, wherein once inserted into the lockable body, the pin contained within the first passage of the lockable body engages with the locking barrel when in the locked position to capture the reversible stop piece and prevent its removal from the lockable body.

15. The reversible ventilation slide inhibitor according to claim 1, wherein once inserted into the lockable body, the in contained in the second passage of the lockable body stabilises the reversible stop piece and prevents rotational movement of the reversible stop piece upon contact with the sliding member.
